(19) United States
(12) Patent Application Publication
(10) Pub. No.: US 2018/0107478 A1
(43) Pub. Date: Apr. 19, 2018

(54) CODING FILTER FOR SHARED SOURCE CODE

(71) Applicant: Microsoft Technology Licensing, LLC, Redmond, WA (US)

(72) Inventors: Paolo Codato, Bellevue, WA (US); Adalberto Foresti, Kirkland, WA (US)

(21) Appl. No.: 15/292,900

(22) Filed: Oct. 13, 2016

(51) Int. Cl. G06F 9/44; G06F 17/30

(52) U.S. Cl. CPC G06F 8/71; G06F 17/30076; G06F 8/33

(57) ABSTRACT

A system for mapping source code from a conforming format to a personalized format includes a mapping module configured in a memory to store a plurality of mapping rules, each of the plurality of mapping rules specifying modification of a source code component from a conforming format to a personalized format and a serializer module configured to apply the one or more of the plurality of mapping rules to a source code file to generate a modified file to be displayed by an integrated development environment (IDE).

### BACKGROUND

Coding conventions are a set of guidelines and recommended programming styles for a given programming language. These conventions usually cover file organization, indentation, comments, declarations, statements, naming conventions, common patterns, programming practices, programming principles, programming rules of thumb, architectural best practices, etc. These are guidelines for software structural quality. By writing consistent code, developers help both themselves and, more importantly, other developers who work in the same codebase. The coding conventions may be formalized into a documented set of rules or an informal set or practices for a development group to follow.

### SUMMARY

A system for mapping source code from a conforming format to a personalized format is disclosed herein. An implementation of the system includes a mapping module configured in a memory to store a plurality of mapping rules, each of the plurality of mapping rules specifying modification of a source code component from a conforming format to a personalized format and a serializer configured to apply the one or more of the plurality of mapping rules to a source code file to generate a modified file to be displayed by an integrated development environment (IDE).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

Example embodiments are illustrated in the referenced figures of the drawings. It is intended that the embodiments and figures disclosed herein are to be considered illustrative rather than restrictive.

FIG. 1 illustrates an example implementation of a system for mapping source code from a conforming format to a personalized format.

FIG. 2 illustrates an example block diagram of a system for providing some functionalities for sharing source code between a developer using a personalized format and a team storing the source code in a conforming format.

FIG. 3 illustrates another example block diagram of a system for providing additional functionalities for sharing source code between a developer using a personalized format and a team storing the source code in a conforming format.

FIG. 4 illustrates example operations of a system disclosed herein for sharing source code between a developer using a personalized format and a team storing the source code in a conforming format.

FIG. 5 illustrates an example computing system that may be useful in implementing the described technology.

### DETAILED DESCRIPTIONS

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, an app, and/or a computer (which may also be a mobile device). By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

In today's software development environments, coding conventions are enforced by one or more processes that may include manual inspection of changes as part of a code review and human-generated feedback to a code submitter. Those conventions generally stem from common practices that were used historically in the industry, or they are adopted by a group of developers through consensus, after weighting different alternatives. Often times though, individual developers develop their own coding conventions, which they wish others in the group to adopt, because they may find those conventions more conducive to productive, quality work than the different, agreed-upon conventions otherwise enforced within the team.

Software developers who collaborate on long term projects routinely establish guidelines to guarantee that all contributors write their source code consistently. However, preferred coding styles evolve much like programming languages and human languages. Especially on longer running projects, there is an inevitable tension between maintaining consistency with coding practices that were in use back when the project was started, and making concessions to more modern and currently recommended approaches. Furthermore, different developers may find themselves more comfortable with different styles, depending on their programming background and level of familiarity with that particular code. Thus, as far as coding practices go, there is generally no “one size fits all” solution.

The technology for sharing source code as disclosed herein provides solutions that allows developers to use personal coding style for coding while still generating code that is generally in compliance with conforming code style (also referred to as canonical code style) that may be required for a software development project. In other words, this technology allows to break the mold of forced compromise on coding practices by allowing different developers to browse the same source code for a given project with a different view—both during development and debugging - that is personalized to their particular style, even as the source code compiles to the same binary code.

In one implementation, the disclosed technology for sharing source code uses mapping rules that modify a given source code component (also referred to as a source code construct) or its position in a customized view of the source code if certain conditions are met. For example, based on particular developer's view preference, the mapping rule ensures that an opening curly brace “{” is not placed on the same line where a function declaration is displayed when viewed by that particular developer. Another example of a mapping rule expands a conditional ternary operator (e.g., “?:”) in a source code component to a regular if/else expression for a developer's view when that source code component is displayed to that developer. Yet another example of such a mapping rule displays a code component to a developer with all statements ending with a semi-colon, even when it is not required that all statements end with a semi-colon.

In one implementation, each developer can specify her own mapping rules. Alternatively, the developer may select from various libraries of mapping rules. The disclosed technology for sharing source code also provides a serializer that consumes or ingests the mapping rules specified by the developer and applies them to a source code file when such source code file is opened in the developer's integrated development environment (IDE). Such a serializer may be provided in the form of a plugin module to the IDE. In another implementation, the IDE may offer cues to the developer about which part of the code component as shown to the developer is modified due to application of a mapping rule. For example, the IDE may highlight the modified code component by underlining the modified code component, or by changing the color of the modified code component as displayed.

In another implementation of the technology for sharing source code as disclosed herein, the application of mapping rules to the symbolic representation of the code may convert a canonical representation of the source code component to personal representation and vice versa. Furthermore, application of the mapping rules may also be selective. Thus, for example, a developer may elect to enforce certain personal mapping rules only when the source file is first loaded, but not to new code that he or she may add later. Alternatively, if a developer writes a new code component in a style that he or she favors, the serializer may apply reverse mapping rules to convert such new code component to the conforming, canonical, or team format used by the project before committing the new code component to source control or source code library. In one implementation, the reverse transformations mapping rule set may be selective. For example, such reverse transformation mapping rule may specify to always move curly braces “{,” “}” to the next line. However, such reverse transformation mapping rule may specify not to transform a new if/else statement in the new code component into ternary operators.

An alternative implementation of the serializer providing support for debugging may also output a line mapping file that associates various lines in a source code where a given code component or code token appears in the conforming form to lines in a visually modified version where the same code token or code component appears. A code token is any sequence of characters that matches to a production rule for a language and a code token can be turned into a node of the “abstract syntax tree” that is the symbolic representation of the source code understood by the compiler. Thus for example, the text for the instruction “IF”, or a curly brace “{”, or a string literal in quotes “SOMETEXT” are all code tokens.

| View | Line | Instruction |
|---|---|---|
| Personal | 130 | if (foo == bar) do_something( ); |
| Canonical | 140 | if (foo == bar) { |
| (Team) | 141 | do_something( ); |
| | 142 | } |

The table above shows the line count as it would appear in the editor for the Personal and Canonical (Team) view respectively, for two different indentation/bracing styles. The table below is a high level representation of the mapping file. However, an on-disk representation may use different conventions such as XML, JSON, or some proprietary binary format.

Line mapping

| Token | Canonical (Team) View | Personal View |
|---|---|---|
| if | 140 | 130 |
| foo | 140 | 130 |
| bar | 140 | 130 |
| do_something( ); | 141 | 130 |

For the table above, note that the start line for the personal view and team view do not have to be the same—in fact they often won't be, because there may be other constructs earlier in the source code that are represented differently, and have altered the line sequencing. In this particular example, the convention chosen by the developer is more succinct than the team's, and it will generally result in shorter source files.

Such line mapping file is used by the editor, which may be a plug-in in the IDE, so that code components such as break points are rendered in proper line of the source code on a computer screen. That view is specific a given set of personal mapping rules when applied to a given source file.

On the other hand, a debugger module may be aware of the executable file and the debugging information generated from the source file serialized in compliance with the conforming or canonical rules. The mapping file is used by the IDE to display the state of the debugging process (e.g. current line of code being debugged) as it applies to the source file once the personal rules have been used. Conversely, when exchanging information with other developers about e.g. a stack trace where an error occurred, the line numbering used by the developer will typically be the canonical one, as shown in a canonical view in editor or IDE (i.e. prior to the application of the personal mapping rules), because that canonical view is that one that is common across all developers of the team.

As an example of a series of interactions between the various modules, the debugger module generates a message to the IDE to the effect: “I stopped at the breakpoint at line 50 (original source file, team rules), token X”. In response, the IDE looks up the mapping file for the line where the token X sits in the file with personal rules to determine that the token “X is now at line 62.” In response to such determination, the editor displays a personal guidelines version of the file with highlights to line 62 on screen as appropriate.

Alternative implementations of the technology for sharing source code as disclosed herein also supports multiple categories of the mapping rules. For example, each category of the mapping rules may be related to different code language (such as C#, java) compared to other categories of the mapping rules. Similarly, each category of the mapping rules may be related to different verbosity level compared to other categories of the mapping rules. In such an implementation, the verbosity level may be indicated on a numeric scale. For example, verbosity level of one (1) indicates use the maximum expressiveness of language constructs allowed without changing semantics (without comments, spaces, group variable declarations, etc.) whereas verbosity level of five (5) indicates clean separation of code components and splitting of instructions in a way that is most understandable by a beginner programmer. As an example, a mapping rule with verbosity level of five (5) may generate a code component by replacing instructions “var A=B+=5;” with “B=B+5; var A=B;”).

In one implementation, a developer may use a slider user interface to select the level of code verbosity and in response to such a selection, a mapping rule associated with the selected verbosity level is applied to modify the source code component for display by the IDE. Thus, for example, as a developer becomes more experienced, the developer may select a lower verbosity level and thus view more compact and powerful source code components in the IDE.

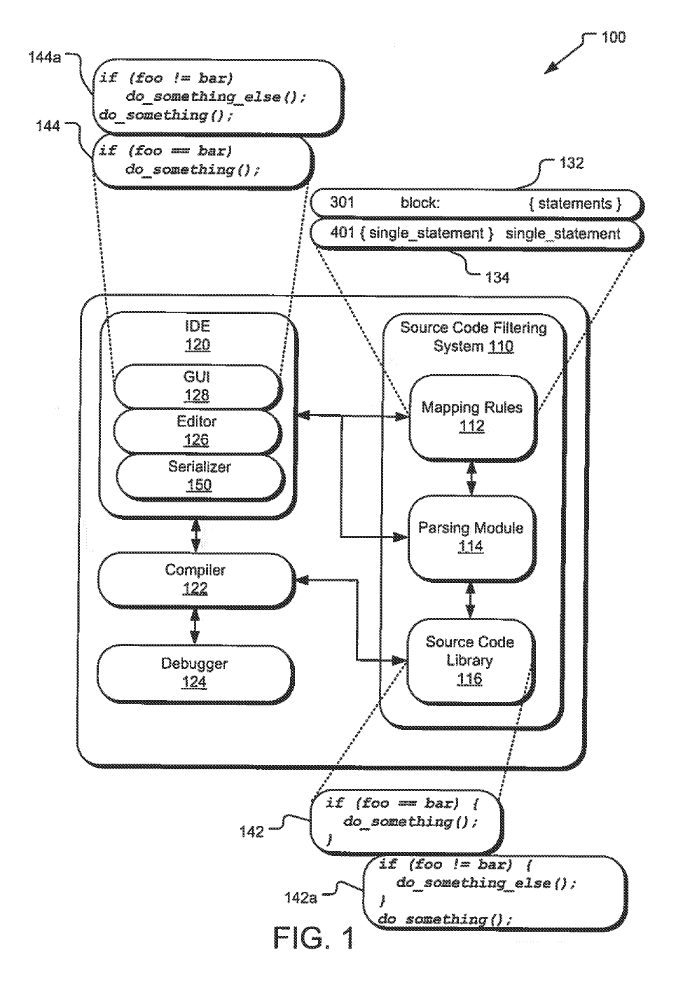

FIG. 1 illustrates an example implementation of a system 100 for mapping source code from a conforming format to a personalized format. Specifically, the system 100 includes a source code filtering system 110 that may be used to filter source code components from a source code library 116 using various mapping rules 112. In the illustrated implementation, the source code library 116 may store a plurality of source code components that are conforming to a team rule as specified a team of developers working on, for example, a software development project. An example of such a source code component is a conforming source code component 142. Specifically, the conforming source code component 142 is a conditional statement.

The mapping rules 112 may include various personalized rules 134 defined by various users as well as various team rules 132 defined by the team of developers working on a software development project. An example of a team Rule 132 is a rule 301 below that does not allow individual statements that are not encased by braces.

| Rule # | Input | Output |
|---|---|---|
| 301 | block: | LBRACE statements RBRACE |

An example of a personal mapping rule 134 is a Rule 401 below that transforms a brace-encased single statement, if one is found in a parse tree, into a non-braced single statement.

| Rule # | Input | Output |
|---|---|---|
| 401 | LBRACE single_statement RBRACE | single_statement |

Here a parse-tree is a data structure that provides a set of production rules for various expressions. An example subset of production rules for various expressions is provided below in Table I:

TABLE I

| # | Expression | Production Rule |
|---|---|---|
| 1 | parsetree: | lines |
| 2 | lines: | lines line/line |
| 3 | line: | . . . |
| . . . | . . . | |
| . . . | . . . | |
| 201 | conditional_statement: | IF expression block |
| 202 | condition: | LPAREN expression RPAREN |
| 203 | block: | LBRACE statements RBRACE/ |
| | | single_statement |
| 204 | statements: | statements single_statement/ |
| | | single_statement |
| 205 | single_statement: | . . . |
| 206 | expression: | . . . |
| . . . | . . . | . . . |

The source code filtering system 110 also includes a parsing module 114 that is configured to build a symbolic representation of the source using language syntax definitions. Thus, for example, for the conforming source code component 142 with the conditional statement, the parsing module 114 may generate a symbolic representation as below:

```
conditional_statement
    IF
    expression
        [...expansion of (foo==bar)]
    block
        LBRACE
        statements
            statement
                [...expansion of do_something( );]
        RBRACE
```

The system 100 also includes an IDE 120 including a graphical user interface (GUI) 128 and an editor 126. The IDE 120 reads the symbolic representation and then applies a personalized rule defined by the developer and stored in the mapping rules 112. In the present case, because the instruction block in the conditional statement, as specified in the symbolic representation above, consists of a single statement, the personal mapping rule 134 (Rule 401) prescribes that the enclosing braces be removed. As a result, the symbolic representation is modified to be as follows:

```
conditional_statement
    IF
    expression
        [...expansion of (foo==bar)]
    block

[symbol]

        statements
            statement
                [...expansion of do_something( );]

[symbol]

```

Note that the parse-tree for the above symbolic representation is still valid as per the language rules defined in Table I above, as the production rule 203 allows for single statements not enclosed in braces. The editor 126 uses the modified symbolic representation above to generate a personalized view 144 of the code to be displayed using the GUI 128. As a result, even though the developer has not modified the source code file in any way, the personalized view 144 is different from the text under source control or source code library 116 as provided by 142. The developer may edit the source code in the personalized code 144 as necessary. For example, the developer may modify the existing code to modified code 144a as follows:

if (foo != bar)
do_something_else( );
do_something( );

The parsing module 114 re-parses the modified source code to generate an updated symbolic representation as provided below:

```
conditional_statement
    IF
    expression
        [expansion of (foo!=bar)]
    block
        statements
            statement
                [expansion of do_something_else( );]
statement
    [expansion of do_something( );]
```

In this case, the “do_something( )” is now correctly sitting at the same level as the “conditional_statement” in the syntax tree (as conveyed by the indentation). That is because according to the language syntax, only one statement can be part of the conditional_statement's block in absence of enclosing braces.

When the developer decides to save the file, the team rules get re-applied to the symbolic representation as part of the file serialization process. In particular, because Rule 301 mandates that a block wraps statements are in braces (effectively, forcing the approved syntax to be a strict subset of the one formally allowed by the programming language designers), the braces are put back in the symbolic representation to make the parse tree compliant with the team rules to generate updated symbolic representation as below:

```
conditional_statement
    IF
    expression
        [expansion of (foo!=bar)]
    block
        LBRACE
        statements
            statement
                [expansion of do_something_else( );]
        RBRACE
statement
    [expansion of do_something( );]
```

The production rules specified in Table I above are applied to translate the tokens of the symbolic representation into text of the modified source code component to generate the modified conforming source code component 142a. Such modified conforming source code component 142a is in compliance with the team rules and is stored in the source code library 116. Once the modified conforming source code component 142a is stored in the source code library 116 every other team member can use such modified conforming source code component 142a.

A serializer 150 also generates a line mapping file that that associates various lines in a conforming source code component 142 where a given code component or code token appears in the conforming form to lines in a visually modified the personalized code 144a where the same code token or code component appears. The system 100 also includes a compiler 122 that generates an executable file. The mapping file generated by the serializer 150 may also be used by the IDE 120. For example, the editor 126 and/or the serializer 150 may use the mapping file to ensure that code components such as break points are rendered at the proper line of the source code in a debug rendering by a debugger module 124 working with the editor 126, while the developer is debugging an executable file.

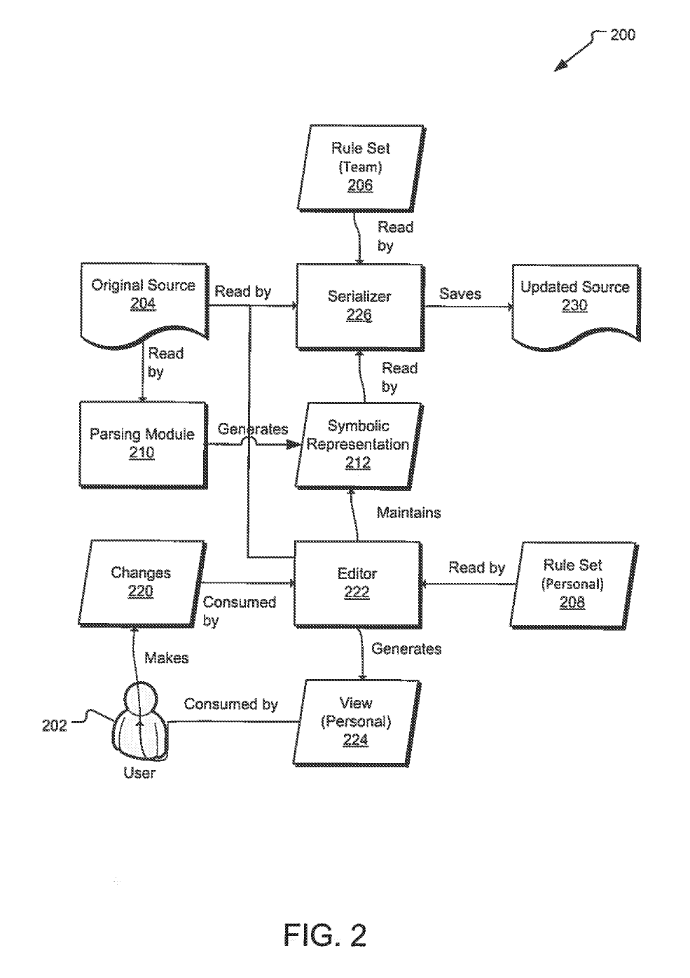

FIG. 2 illustrates example block diagram of a system 200 for sharing source code between a developer using a personalized format and a team storing the source code in a conforming format. The system 200 provides a user 202 a personalized view 224 of source code components. An original version of the source code 204 is read by a parsing module 210. The parsing module 210 interprets the source code 204 and generates a symbolic representation 212 that is read by a serializer 226 to generate an updated source code 230. The serializer 226 may use a team rule set 206 to serialize the original source code 204 based on the symbolic representation 212. The serializer 226 also generates a line mapping file that that associates various lines in a conforming source code component where a given code component or code token appears in the conforming form to lines in a visually modified the personalized code where the same code token or code component appears.

An editor 222, such as an editor of an IDE uses a personal rule set 208 to generate the personalized view 224 of the original source 204. The editor 222 also allows the user 202 to make changes 220 to the personalized view 224 of the source code. The changes 220 are consumed by the editor 222. Furthermore, the editor 222 also updates the symbolic representation 212 to reflect the changes 220.

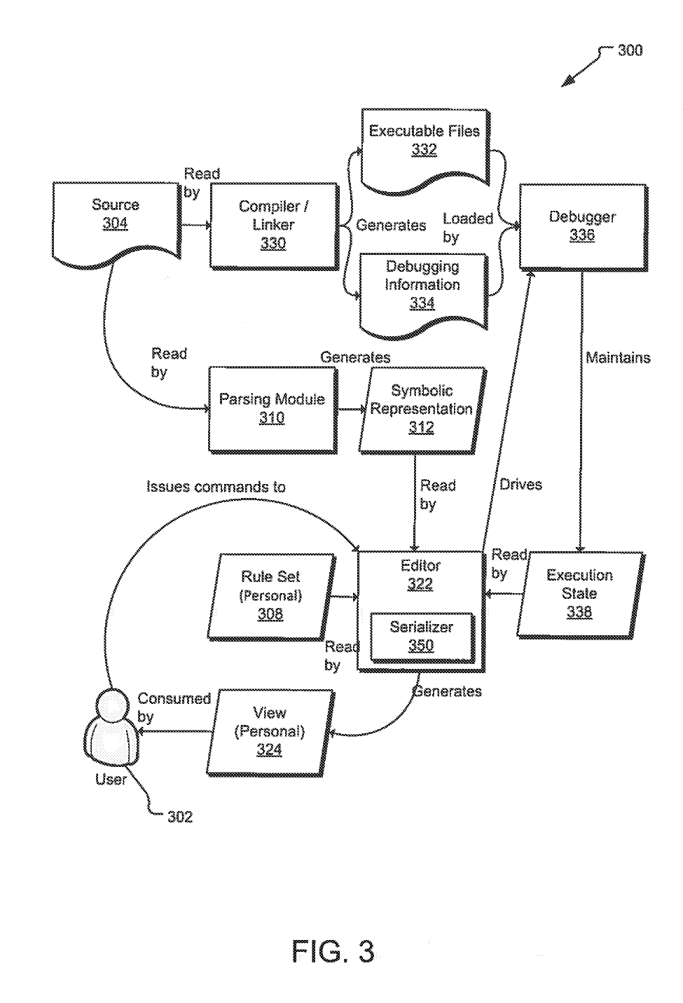

FIG. 3 illustrates another example block diagram of a system 300 for providing additional functionalities for sharing source code between a developer using a personalized format and a team storing the source code in a conforming format. The system 300 provides a user 302 a personalized view 324 of source code components. An original version of the source code 304 is read by a parsing module 310. The parsing module 310 generates a symbolic representation 312 which may be read by an editor 322 of an IDE. The editor 322 uses the symbolic representation together with a personal rule set 308 to generate the personalized view 324. A serializer module 350 generates a line mapping file that associates various lines in a conforming source code component where a given code component or code token appears in the conforming form to lines in a visually modified the personalized code where the same code token or code component appears. The serializer 350 may be a component or a plug-in extension of the editor 322.

A compiler/linker 330 reads the source code 304 to generate executable files 332 and debugging information 334. The compiler/linker 330 may generate the executable files at assembly level, which may be converted to object code by an assembler. A debugging module 336 may read the executable files 332 and the debugging information 334 and maintain mapping of execution states 338 to instructions in the source code 304. The debugging module 336 may also load and run the executable files 332 instruction by instruction. The execution state 338 includes content of the memory allocated to the executable files 332 as it is running including: variables in use and their values, values of the CPU's registries, call stack containing functions being called, and a list of active threads and current instruction(s) they are executing.

The debugging information 334 may include a set of data that may help convert the execution state 338 as represented in 0′s and l′s in the machine into something that the developer can understand. Thus, for example, data structures in the execution states 338 are mapped back to the variable names in the source code 304, functions on the call stack are mapped to their human-readable names, etc. The debugging module 336 may be driven by the editor 322. The editor 322 presents debugging information 334 for various execution states 338 to the user 302 using the symbolic representation 312 and the personalized rule set 308 such that the user 302 sees the debugging information 334 aligned with the personalized view 324 of the source code 304.

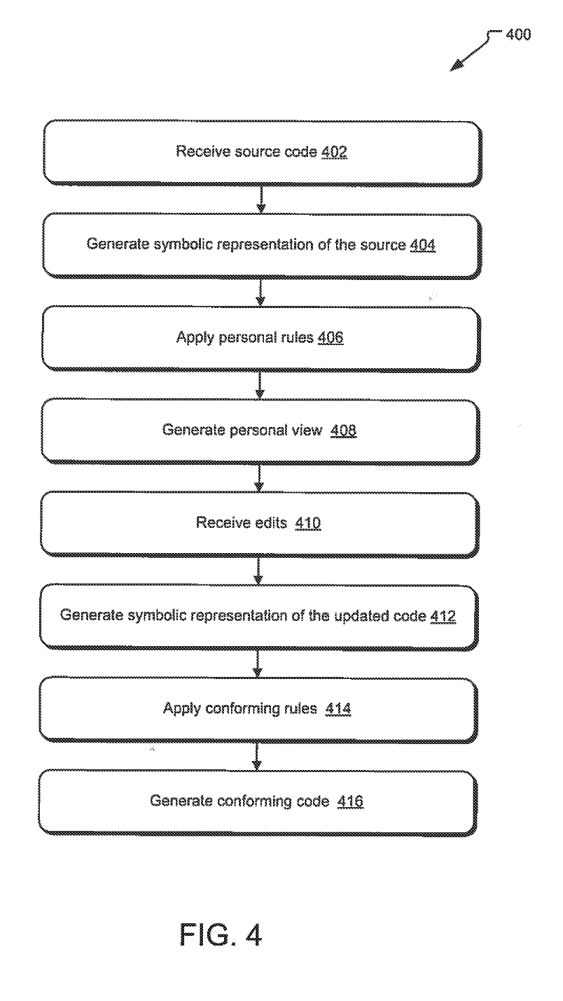

FIG. 4 illustrates operations 400 of a system disclosed herein for sharing source code between a developer using a personalized format and a team storing the source code in a conforming format. Specifically, the operations 400 allows a user to work with a personalized view of source code while still maintaining source code in a source code library in the conforming format. An operation 402 receives source code in a conforming format, such as a format preferred by a team of developers, or an organization. An example of such conforming source code is as presented below:

if (foo == bar) {
do_something( );
}

An operation 404 parses the conforming code as per language syntax definition and generates a symbolic representation of the conforming source code as below:

```
conditional_statement
    IF
    expression
        [...expansion of (foo==bar)]
    block
        LBRACE
        statements
            statement
                [...expansion of do_something( );]
        RBRACE
```

An operation 406 applies personalized rules to the above symbolic representation. For example, for a developer that prefers to minimize clutter in the source code and choses to adopt a rule that transforms a brace-encased single statement if found in the symbolic representation, into a non-braced signal statement, such personal Rule 401 may be given as follows:

| Rule # | Input | Output |
|---|---|---|
| 401 | LBRACE single_statement RBRACE | single_statement |

In such a case, the operation 406 applies the Rule 401 to the symbolic representation to generate a modified symbolic representation as follows:

```
conditional_statement
    IF
    expression
        [...expansion of (foo==bar)]
    block

[symbol]

        statements
            statement
                [...expansion of do_something( );]

[symbol]

```

Note that the parse-tree for the above symbolic representation is still valid as per the language rules defined in Table I above as the production rule 203 (as shown in FIG. 2) allows for single statements not enclosed in braces.

An operation 408 uses the modified symbolic representation to generate a personalized view of the code as provided below:

if (foo == bar)
do_something( );

An operation 410 receives edits to the personalized view of the source code. For example, a user may modify the above source code as follows:

if (foo != bar)
do_something_else( );
do_something( );

An operation 412 generates symbolic representation of the updated code as provided below:

```
conditional_statement
    IF
    expression
        [expansion of (foo!=bar)]
    block
        statements
            statement
                [expansion of do_something_else( );]
statement
    [expansion of do_something( );]
```

An operation 414 applies conforming rules, such as the following Rule 301, which mandates that a block wraps statements in braces.

| Rule # | Input | Output |
|---|---|---|
| 301 | block: | LBRACE statements RBRACE |

Aa a result, the symbolic representation of the updated code is modified as follows:

```
conditional_statement
    IF
    expression
        [expansion of (foo!=bar)]
    block
        LBRACE
        statements
            statement
                [expansion of do_something_else( );]
        RBRACE
statement
    [expansion of do_something( );]
```

An operation 416 uses the above symbolic representation to generate updated source code as follows:

if (foo != bar) {
do_something_else( );
}
do_something( );

This updated source code is in compliance with the team rules and it is stored in a source code library.

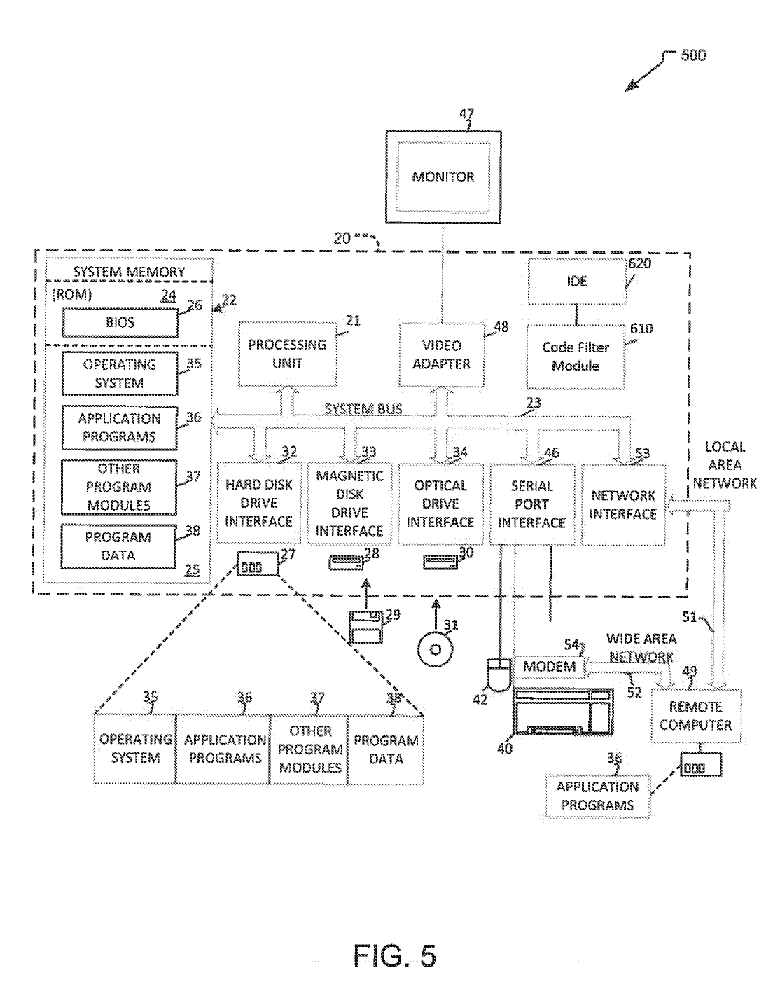

FIG. 5 illustrates an example system 500 that may be useful in implementing the described technology for sharing source code between various users using different rules. The example hardware and operating environment of FIG. 5 for implementing the described technology includes a computing device, such as a general purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units 21, commonly referred to as a parallel processing environment. The computer 20 may be a conventional computer, a distributed computer, or any other type of computer; the implementations are not so limited. An implementation of the computer 20 may be used to implement the system for sharing source code as disclosed herein.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk drive 27, magnetic disk 29, optical disk 31, ROM 24, or RAM 25, including an operating system 35, one or more application programs 36, other program modules 37, and program data 38. For example, one or more modules of the system for sharing source code as disclosed herein may be implemented with instructions on the hard disk drive 27, magnetic disk 29, optical disk 31, ROM 24, or RAM 25. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor 47, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are examples and other means of communications devices for establishing a communications link between the computers may be used.

In an example implementation, software or firmware instructions for sharing source code may be stored in memory 22 and/or storage devices 29 or 31 and processed by the processing unit 21. Rules for sharing source code may be stored in memory 22 and/or storage devices 29 or 31 as persistent datastores. For example, a parsing module may be implemented with instructions stored in the memory 22 and/or storage devices 29 or 31 and processed by the processing unit 21. Similarly, one or more modules of the system for sharing source code may also be implemented with instructions stored in the memory 22 and/or storage devices 29 or 31 and processed by the processing unit 21. The memory 22 may be used to store one or more modules for the system for sharing source code.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The system for sharing source code as disclosed herein may include a variety of tangible computer-readable storage media and intangible computer-readable communication signals. Tangible computer-readable storage can be embodied by any available media that can be accessed by the system for sharing source code as disclosed herein and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the system for sharing source code as disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct- wired connection, and wireless media such as acoustic, RF, infrared and other wireless media.

The system for sharing source code as disclosed herein provides technical improvements to the process of software development. Specifically, the process of software development requires consistency between the coding methods used by various developers that are part of the software development team as well as efficient use of developers' time. By providing the capability to convert source code between personalized format and canonical format the system for sharing source code allows single form of source code components, as stored in the source code library or source control, among a large number of developers using personalized format to view the source code and to modify such personalized version of the source code. Thus, the system of sharing source code as disclosed herein provides technological benefits to the process of sharing source code among a number of developers using different source code development format.

A system disclosed herein comprises a memory, one or more processor units, a mapping module configured in the memory to store a plurality of mapping rules, each of the plurality of mapping rules specifying modification of a source code component from a first format to a second format, a serializer comprising a plurality of instructions stored in the memory and executed by the one or more processor units to apply one or more of the plurality of mapping rules to a source code file with the source code component in the first format to generate a modified file with the source code component in the first format, and an integrated development environment (IDE) comprising a plurality of instructions stored in the memory and executed by the one or more processor units to display the modified file.

An alternative implementation of the system further comprises a plurality of instructions to generate a line mapping file to associate each of a plurality of lines in the source code file where the source code component is located with a line in the modified file. Yet another implementation of the system comprises an editor module comprising a plurality of instructions stored in the memory and executed by the one or more processor units to determine a location of a breakpoint injected in the source code file based on the line mapping file. Alternatively, the mapping module is further configured to store plurality of reverse mapping rules, each of the plurality of reverse mapping rules specifying modification of the source code component from the second format to the first format.

In an alternative implementation, the IDE further comprises a plurality of instructions executed by the one or more processor units to highlight one or more source code components of the displayed modified file. Alternatively, the plurality of mapping rules comprises multiple categories of mapping rules, each category of mapping rules related to a different code language compared to other categories of the mapping rules. Yet alternatively, the plurality of mapping rules comprises multiple categories of mapping rules, each category of mapping rules related to a different verbosity level compared to other categories of the mapping rules.

A method disclosed herein comprises generating a plurality of mapping rules, each of the plurality of mapping rules specifying modification of a source code component from a first format to a second format, applying one or more of the plurality of mapping rules to a source code file with the source code component in the first format to generate a modified file with the source code component in the second format, and displaying the modified file in an integrated development environment (IDE). An alternative implementation of the method further comprises generating a line mapping file to associate each of a plurality of lines in the source code file where the source code component is located with a line in the modified file.

An implementation of the method further comprises generating a plurality of reverse mapping rules, each of the plurality of reverse mapping rules specifying modification of the source code component from the second format to the first format and applying one or more of the reverse mapping rules to the source code component of the second format to generate a source control source code component. Another implementation of the method further comprises highlighting one or more source code components of the displayed modified file. Yet another implementations of the method comprise generating a stack trace using line numbers of the source code file in the first format or determining a location of a breakpoint injected in the source code file based on the line mapping file. In one implementation of the method, the plurality of mapping rules comprises multiple categories of mapping rules, each category of mapping rules related to a different code language compared to other categories of the mapping rules.

A physical article of manufacture including one or more tangible computer-readable storage media, encoding computer-executable instructions for executing on a computer system a computer process, wherein the computer process comprises generating a plurality of mapping rules, each of the plurality of mapping rules specifying modification of a source code component from a first format to a second format, generating a line mapping file to associate each of a plurality of lines in the source code file where the source code component is located with a line in a modified file, and applying one or more of the plurality of mapping rules to the source code file to generate the modified file to be displayed by an integrated development environment (IDE).

In one implementation, the computer process further comprises generating a plurality of reverse mapping rules, each of the plurality of reverse mapping rules specifying modification of the source code component from the second format to the first format and applying one or more of the reverse mapping rules to the source code component of the second format to generate a source control source code component. In another implementation, the computer process further comprises highlight one or more source code components of the displayed modified file. Yet alternatively, the computer process further comprises determining a location of a breakpoint injected in the source code file based on the line mapping file. In another implementation, the plurality of mapping rules comprises multiple categories of mapping rules, each category of mapping rules related to a different verbosity level compared to other categories of the mapping rules.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A system comprising:
memory;
one or more processor units;
a mapping module configured in the memory to store a plurality of mapping rules, each of the plurality of mapping rules specifying modification of a source code component from a first format to a second format;
a serializer comprising a plurality of instructions stored in the memory and executed by the one or more processor units to apply one or more of the plurality of mapping rules to a source code file with the source code component in the first format to generate a modified file with the source code component in the first format; and
an integrated development environment (IDE) comprising a plurality of instructions stored in the memory and executed by the one or more processor units to display the modified file.

2. The system of claim 1, wherein the serializer further comprising a plurality of instructions to generate a line mapping file to associate each of a plurality of lines in the source code file where the source code component is located with a line in the modified file.

3. The system of claim 2, further comprising an editor module comprising a plurality of instructions stored in the memory and executed by the one or more processor units to determine a location of a breakpoint injected in the source code file based on the line mapping file.

4. The system of claim 1, wherein the mapping module further configured to store plurality of reverse mapping rules, each of the plurality of reverse mapping rules specifying modification of the source code component from the second format to the first format.

5. The system of claim 4, wherein the serializer further comprising a plurality of instructions to apply one or more of the reverse mapping rules to the source code component of the second format to generate a source control source code component.

6. The system of claim 1, wherein the IDE further comprising a plurality of instructions executed by the one or more processor units to highlight one or more source code components of the displayed modified file.

7. The system of claim 1, wherein the plurality of mapping rules comprises multiple categories of mapping rules, each category of mapping rules related to a different code language compared to other categories of the mapping rules.

8. The system of claim 1, wherein the plurality of mapping rules comprises multiple categories of mapping rules, each category of mapping rules related to a different verbosity level compared to other categories of the mapping rules.

9. A method comprising:
generating a plurality of mapping rules, each of the plurality of mapping rules specifying modification of a source code component from a first format to a second format;
applying one or more of the plurality of mapping rules to a source code file with the source code component in the first format to generate a modified file with the source code component in the second format; and
displaying the modified file in an integrated development environment (IDE).

10. The method of claim 9, further comprising generating a line mapping file to associate each of a plurality of lines in the source code file where the source code component is located with a line in the modified file.

11. The method of claim 9, further comprising:
generating a plurality of reverse mapping rules, each of the plurality of reverse mapping rules specifying modification of the source code component from the second format to the first format; and
applying one or more of the reverse mapping rules to the source code component of the second format to generate a source control source code component.

12. The method of claim 9, further comprising highlighting one or more source code components of the displayed modified file.

13. The method of claim 9, further comprising generating a stack trace using line numbers of the source code file in the first format.

14. The method of claim 9, further comprising determining a location of a breakpoint injected in the source code file based on the line mapping file.

15. The method of claim 9, wherein the plurality of mapping rules comprises multiple categories of mapping rules, each category of mapping rules related to a different code language compared to other categories of the mapping rules.

16. A physical article of manufacture including one or more tangible computer-readable storage media, encoding computer-executable instructions for executing on a computer system a computer process, the computer process comprising:
generating a plurality of mapping rules, each of the plurality of mapping rules specifying modification of a source code component from a first format to a second format;
generating a line mapping file to associate each of a plurality of lines in the source code file where the source code component is located with a line in a modified file; and
applying one or more of the plurality of mapping rules to the source code file to generate the modified file to be displayed by an integrated development environment (IDE).

17. The physical article of manufacture of claim 16, wherein the computer process further comprising:
generating a plurality of reverse mapping rules, each of the plurality of reverse mapping rules specifying modification of the source code component from the second format to the first format; and
applying one or more of the reverse mapping rules to the source code component of the second format to generate a source control source code component.

18. The physical article of manufacture of claim 17, wherein the computer process further comprising highlight one or more source code components of the displayed modified file.

19. The physical article of manufacture of claim 18, wherein the computer process further comprising determining a location of a breakpoint injected in the source code file based on the line mapping file.

20. The physical article of manufacture of claim 16, wherein the plurality of mapping rules comprises multiple categories of mapping rules, each category of mapping rules related to a different verbosity level compared to other categories of the mapping rules.
